(19) United States
(12) Patent Application Publication
(10) Pub. No.: US 2016/0024971 A1
(43) Pub. Date: Jan. 28, 2016

(54) VANE ASSEMBLY

(71) Applicant: Rolls-Royce PLC, London (GB)

(72) Inventors: James C PEARCE, Surrey (GB); Steven M BARNES, Gloucester (GB)

(21) Appl. No.: 14/754,098

(22) Filed: Jun. 29, 2015

(30) Foreign Application Priority Data
Jul. 22, 2014 (GB) 1412960.5

(51) Int. Cl. F01D 25/28; F01D 9/04

(52) U.S. Cl. CPC F01D 25/28; F01D 9/041; F05D 2220/32; F05D 2240/12

(57) ABSTRACT

An annular support for a vane assembly including a vane having an aerofoil section with a radially inner base and a radially outer tip is provided. The annular support has a gas path surface which, in use, faces an annular gas path. In some aspects, the annular support is locally thickened by a projection extending radially from the gas path surface, the projection at least partly defining the perimeter of an aperture for receiving the base or tip of the aerofoil section. In some aspects, there is a liner lining the aperture and the liner extends from the aperture beyond the gas path surface.

### FIELD OF THE INVENTION

The present invention relates to a vane assembly for use in a gas turbine engine as well as an annular support and a casing for use in such a vane assembly.

### BACKGROUND OF THE INVENTION

With reference to FIG. 1, a ducted fan gas turbine engine is generally indicated at 10 and has a principal and rotational axis X-X. The engine comprises, in axial flow series, an air intake 11, a propulsive fan 12, an intermediate pressure compressor 13, a high-pressure compressor 14, combustion equipment 15, a high-pressure turbine 16, an intermediate pressure turbine 17, a low-pressure turbine 18 and a core engine exhaust nozzle 19. A nacelle 21 generally surrounds the engine 10 and defines the intake 11, a bypass duct 22 and a bypass exhaust nozzle 23.

During operation, air entering the intake 11 is accelerated by the fan 12 to produce two air flows: a first air flow A into the intermediate pressure compressor 13 and a second air flow B which passes through the bypass duct 22 to provide propulsive thrust. The intermediate pressure compressor 13 compresses the air flow A directed into it before delivering that air to the high pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the nozzle 19 to provide additional propulsive thrust. The high, intermediate and low-pressure turbines respectively drive the high and intermediate pressure compressors 14, 13 and the fan 12 by suitable interconnecting shafts.

The propulsive fan 12 and the compressors 13, 14 typically comprise a number of vanes or stators held in position within a gas path between an outer annular casing and a concentric inner annular casing, each vane having an aerofoil section bridging the annular gap between the casings. In some cases, the ends of the aerofoil sections are fixed or “potted” within apertures provided in the casings. The potted ends are provided with a collar of potting material which is typically a conformable material such as rubber. The potting material acts to constrain the ends of the aerofoil section within the casing apertures and to dampen vibration during engine operation.

There is a minimum “potting length” necessary to achieve the required constraint and damping of the vanes. Often, there is insufficient room to be able to easily accommodate the required minimum length. Uniform thickening of the casings is undesirable because the volume of the gas path is reduced which reduces engine efficiency. Furthermore, additional material will add undesirable weight to the engine.

Accordingly, there is a need to provide a vane assembly which can be used in a constrained space to provide the required minimum potting length and which does not unacceptably compromise engine efficiency.

### SUMMARY OF THE INVENTION

In a first aspect, the present invention provides an annular support for a vane, the vane having an aerofoil section with a radially inner base and a radially outer tip, the annular support comprising a gas path surface which, in use, faces an annular gas path,
wherein the annular support is locally thickened by a projection extending radially from the gas path surface, the projection at least partly defining the perimeter of an aperture for receiving the tip or base of the aerofoil section.

In a second aspect, the present invention provides a casing for a vane, the vane having an aerofoil section with a radially inner base and a radially outer tip, the casing comprising a radially inner casing and a radially outer casing defining an annular gas path therebetween,
wherein the radially inner casing is locally thickened by a projection extending radially outwards into the gas path, the projection at least partly defining the perimeter of an aperture for receiving the base of the aerofoil section and/or the radially outer casing is locally thickened by a projection extending radially inwards into the gas path, the projection at least partly defining the perimeter of an aperture for receiving the tip of the aerofoil section.

In a third aspect, the present invention provides a vane assembly comprising:
a vane having an aerofoil section with a radially inner base and a radially outer tip;
a radially inner casing and a radially outer casing defining an annular gas path therebetween,
wherein the radially inner casing is locally thickened by a projection extending radially outwards into the gas path, the projection at least partly defining the perimeter of an aperture which houses the base of the aerofoil section and/or the radially outer casing is locally thickened by a projection extending radially inwards into the gas path, the projection at least partly defining the perimeter of an aperture which houses the tip of the aerofoil section.

By locally thickening the support/casing at least partly around the perimeter of the aperture, it is possible to obtain the required potting length to ensure sufficient constraint of the vane without comprising the engine efficiency by significantly reducing the volume of the gas path.

Optional features of the invention will now be set out. These are applicable singly or in any combination with any aspect of the invention.

In some embodiments, the or each projection extends around (and defines) the entire perimeter of the respective aperture.

In some embodiments, the or each projection has a radially extending side surface that is curved or sloped e.g. a concave radially extending side surface. This improves aerodynamic flow of gas in the gas path. In other embodiments, the radially extending side surface may be a convex radially extending side surface.

In some embodiments, the radially extending side surface extends to a projection edge. The projection edge may transition to an axially extending end surface. The axially extending end surface may be planar and may be parallel to the gas path surface/casing. The axially extending end surface may be curved/sloped e.g. convex.

In some embodiments, the or each aperture is at least partly lined with a liner.

In some embodiments, the liner is flush with the projection edge and/or with the end surface of the projection.

In some embodiments, the liner extends beyond the projection i.e. beyond the projection edge or the end surface of the projection.

In some embodiments, the liner has an outer surface which extends beyond the projection edge and which continues the slope/curve of the projection side surface.

In some embodiments, the aperture extends into the annular support/casing i.e. the aperture has a greater depth than the height of the projection.

In some embodiments of the second and third aspects, the radially inner casing is locally thickened by the projection extending radially outwards into the gas path, the projection at least partly defining the perimeter of the aperture housing/for receiving the base of the aerofoil section and the radially outer casing is locally thickened by the projection extending radially inwards into the gas path, the projection at least partly defining the perimeter of the aperture housing the tip of the aerofoil section.

In a fourth aspect, the present invention provides an annular support for a vane, the vane having an aerofoil section with a radially inner base and a radially outer tip, the annular support comprising:
a gas path surface which, in use, faces an annular gas path, the gas path surface having an aperture for receiving the tip or base of the aerofoil section, and
a liner lining the aperture,
wherein the liner extends from the aperture beyond the gas path surface.

In a fifth aspect, the present invention provides a casing for a vane, the vane having an aerofoil section with a radially inner base and a radially outer tip, the casing comprising:
a radially inner casing having an aperture for receiving the radially inner base of the vane; and
a radially outer casing having an aperture for receiving the radially outer tip of the vane, the radially inner casing and radially outer casing defining an annular gas path therebetween; wherein the aperture in the radially inner casing is provided with a liner extending radially beyond the aperture outwards into the gas path and/or the aperture in the radially outer casing is provided with a liner extending radially beyond the aperture inwards into the gas path.

In a sixth aspect, the present invention provides a vane assembly comprising:
a vane having an aerofoil section with a radially inner base and a radially outer tip;
a radially inner casing having an aperture housing the radially inner base of the vane; and
a radially outer casing having an aperture housing the radially outer tip of the vane, the radially inner casing and radially outer casing defining an annular gas path therebetween;
wherein the aperture in the radially inner casing is provided with a liner extending radially beyond the aperture outwards into the gas path and/or the aperture in the radially outer casing is provided with a liner extending radially beyond the aperture inwards into the gas path.

By providing a liner that extends beyond the gas path surface/into the annular gas path, it is possible to obtain the required potting length to ensure sufficient constraint of the vane without comprising the engine efficiency by significantly reducing the volume of the gas path.

In some embodiments, the aperture in the radially inner casing is provided with a liner extending radially outwards into the gas path and the aperture in the radially outer casing is provided with a liner extending radially inwards into the gas path.

In some embodiments, the portion of the or each liner extending beyond the respective aperture has a radially extending side surface which may be curved or sloped e.g. a concave radially extending side surface. This improves aerodynamic flow of gas in the gas path. In other embodiments, the radially extending side surface may be a convex radially extending side surface.

The radially extending side surface may be provided with a smoothing coating e.g. a silicone coating for improving aerodynamic flow in the gas path. The smoothing coating may have a radially extending side surface which may be curved or sloped e.g. a concave radially extending side surface. The smoothing coating may contain fibrous reinforcements. It may be formed of rubber, chopped fibre filled rubber, injection moulded plastic material, chopped fibre compression moulded composite or metal e.g. aluminium.

The radially extending side surface of the liner may be provided with a protective element e.g. a sheath of plastics material. The protective element may have a first end for abutting the gas path surface/casing and a second end for abutting the vane. The first end of the protective element may be embedded into the gas path surface/casing. The protective element retains the potting material within the aperture and may provide some erosion protection. It may be formed of the materials listed above for the smoothing coating.

The liner may have a flange portion extending axially in abutment with the gas path surface/casing.

In some embodiments, the liner(s) is/are at least partly formed of a potting compound i.e. conformable (i.e. easily moulded/shaped) material such as a thermo-setting plastics material (e.g. a polyurethane or polyester), an epoxy adhesive material or a silicone rubber, optionally reinforced e.g. with fibres such as glass or carbon fibres. This provides constraint and damping of vibrations during engine operation.

In some embodiments, the liner(s) comprise a respective mechanical spring portion. In these cases, a smoothing coating and/or protective element (as described above) can be used to cover the spring portion to improve aerodynamic flow in the gas flow path.

In some embodiments, the liner(s) comprise(s) a rigid plug. The rigid plug has a central aperture for receiving/housing the tip/base of the vane and the central plug aperture may be lined with a potting compound (described above). The rigid plug may also have a lining of potting compound on its outer surface where it abuts the aperture in the annular support/casing. The rigid plug may have a flange portion extending axially in abutment with the gas path surface/casing. The flange portion may have a radially extending side surface which may be curved or sloped e.g. a concave radially extending side surface.

The or each liner may be affixed into the respective aperture using adhesive.

In some embodiments, the vane is an outlet guide vane (OGV), e.g. a propulsive fan OGV.

In some embodiments, the vane assembly comprises a plurality of vanes each having an aerofoil section with a radially inner base and a radially outer tip. In these embodiments, the annular support or the radially inner casing and/or the radially outer casing each comprises a plurality of apertures and associated projections and/or liners.

In a seventh aspect, the present invention provides a gas turbine engine comprising an annular support according to the first or fourth aspects, a casing according to the second or fifth aspects or a vane assembly according to the third or sixth aspects.

### BRIEF DESCRIPTION OF THE DRAWINGS

Embodiments of the invention will now be described by way of example with reference to the accompanying drawings in which:

FIG. 1 shows a known ducted gas turbine engine;

FIG. 2 shows a perspective view of a first embodiment of the present invention;

FIG. 3 shows a cross section through a portion of the embodiment shown in FIG. 2;

FIG. 4 shows a second embodiment of the present invention;

FIG. 5 shows a third embodiment of the present invention;

FIG. 6 shows a fourth embodiment of the present invention;

FIG. 7 shows a further view of the third embodiment of the present invention;

FIG. 8 shows a fifth embodiment of the present invention;

FIG. 9 shows a sixth embodiment of the present invention;

FIG. 10 shows a seventh embodiment of the present invention;

FIG. 11 shows an eighth embodiment of the present invention; and.

FIG. 12 shows a ninth embodiment of the present invention.

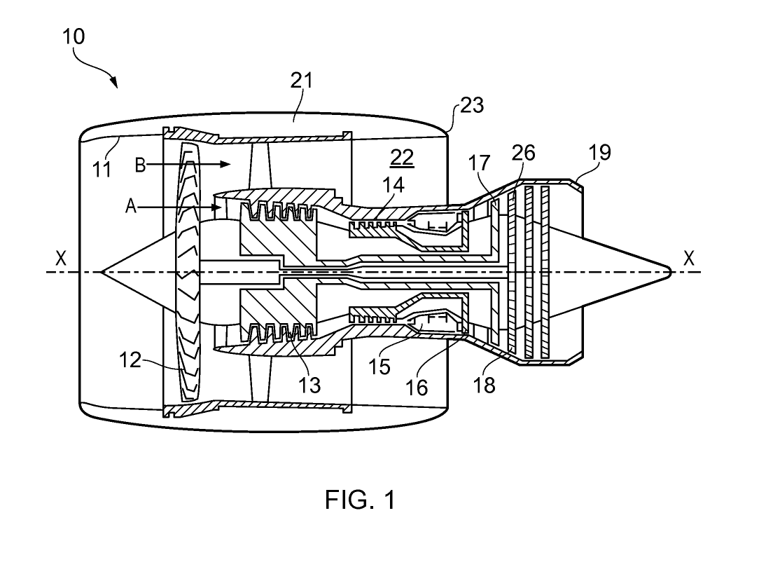

### DETAILED DESCRIPTION AND FURTHER OPTIONAL FEATURES OF THE INVENTION

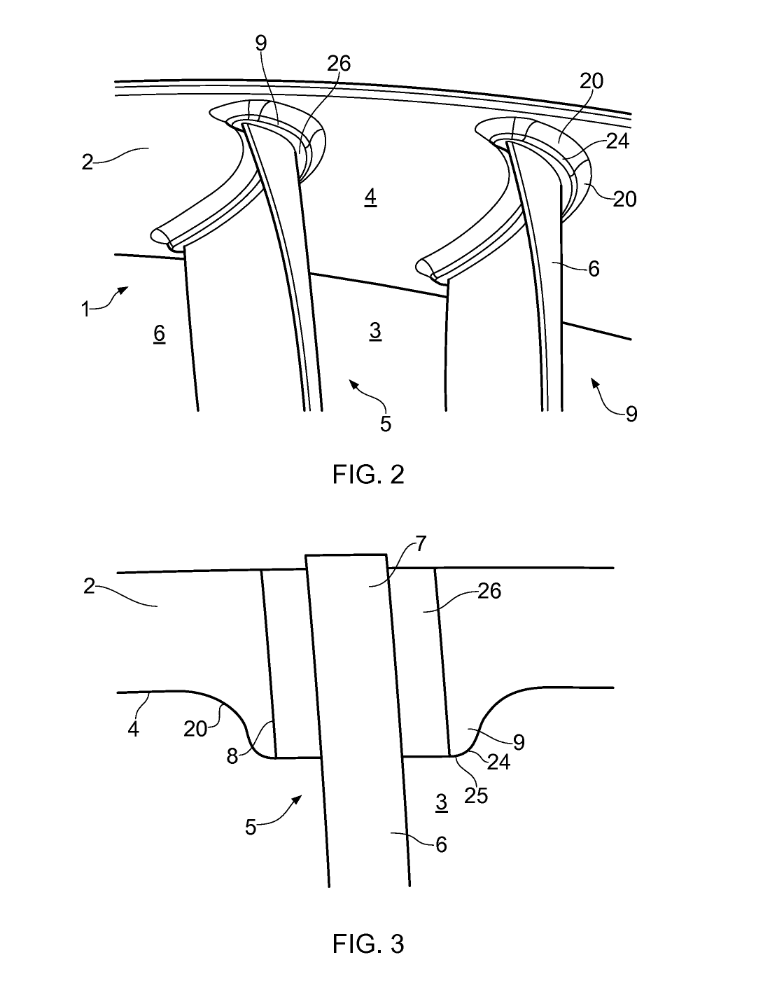

FIG. 2 shows a perspective view of a portion of a vane assembly forming a first preferred embodiment of the present invention. FIG. 3 shows a cross-section through one of the vanes shown in FIG. 2.

The vane assembly 1 comprises an annular support which forms a radially outer casing 2. A concentric radially inner casing is also provided but is not shown. The radially outer casing 2 and radially inner casing define an annular gas path 3. The radially outer casing 2 has a gas path surface 4 which faces into the gas path 3.

The portion of the vane assembly shown comprises two vanes 5. Each vane comprises an aerofoil section 6 having a tip 7 (shown in FIG. 3) and a radially opposed base (not shown).

The tip 7 is received in an aperture 8, the perimeter of which is defined by a projection 9 which is formed by locally thickening the outer casing 2 such that the projection extends radially outwards into the gas path.

The aperture 8 has a cross-sectional profile matching the radial cross-sectional profile of the aerofoil section 6 (albeit of a larger size).

The aperture 8 has a greater depth than the height of the projection such that it extends into the outer casing 2

The projection 9 has a concave radially extending side surface 20. This improves aerodynamic flow of gas in the gas path 3. The radially extending side surface 20 extends to a projection edge 24. The projection edge 24 transitions to an axially extending end surface 25. The axially extending end surface 25 is planar and parallel to the gas path surface 4.

The aperture 8 is lined with a liner 26 formed of a potting compound such as silicone rubber. This provides damping of vibrations during engine operation.

The liner 26 is flush with the end surface 25 of the projection 9.

By locally thickening the casing 2 around the perimeter of the aperture 8 housing the tip 7 of the aerofoil section 6 of the vane 5, it is possible to obtain the required depth of aperture 8 to ensure sufficient constraint of the vane 5 without comprising the engine efficiency by significantly reducing the volume of the gas path 3.

Although not shown, the base is received in a corresponding aperture in the radially inner casing and the radially inner casing is locally thickened around the perimeter of the aperture by a projection extending radially outwards into the gas path.

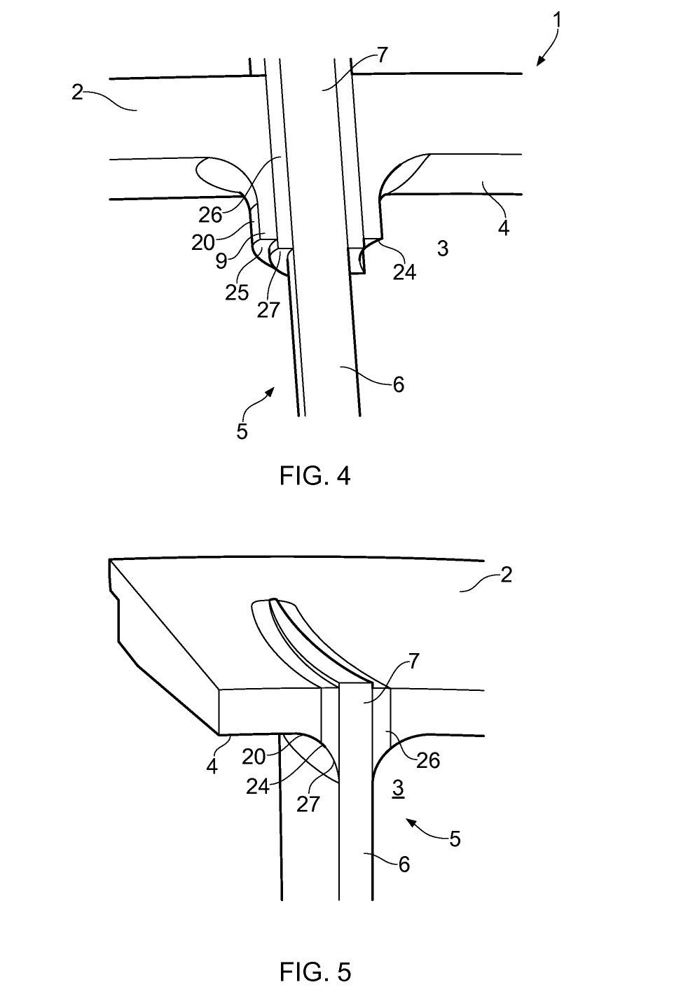

A second embodiment is shown in FIG. 4. In this embodiment, the liner 26 extends beyond the projection 9 i.e. beyond the end surface 25 of the projection 9.

A third embodiment is shown in FIG. 5. In this embodiment, the liner 26 has an outer surface 27 which extends beyond the projection edge 24 and which continues the curve of the projection side surface 20. This curved shape offers an improved aerodynamic shape and thus improved aerodynamic efficiency.

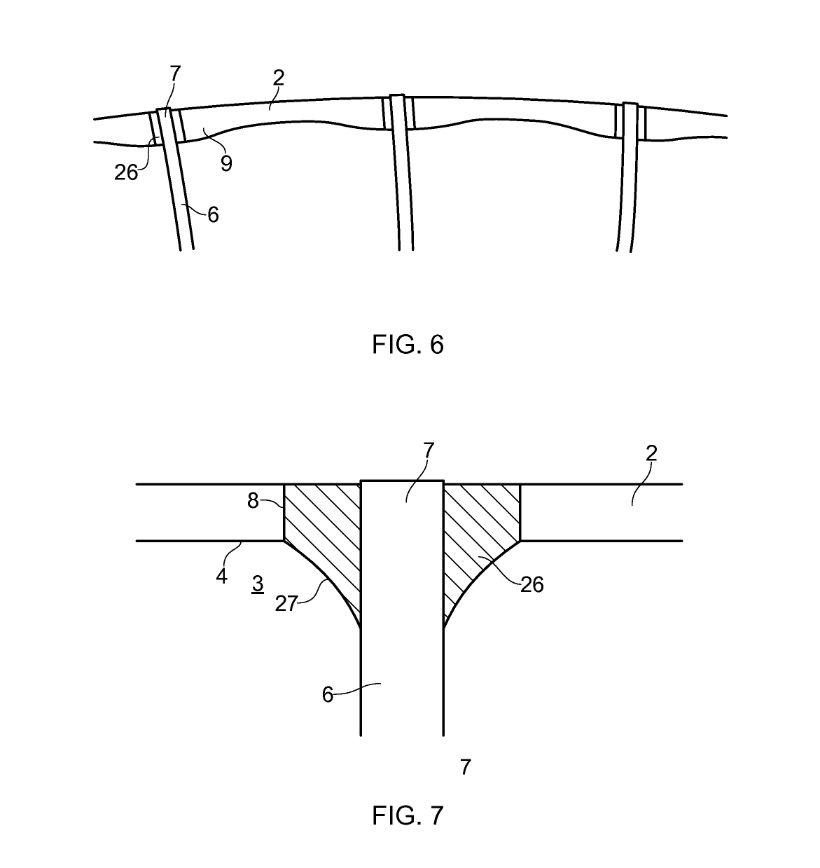

A fourth embodiment is shown in FIG. 6. In this embodiment, the projections 9 have a shallow convex profile and a greater circumferential extension than in previously described embodiments.

Further embodiments are shown in FIGS. 7-12.

In these embodiments, the vane assembly 1 comprises an annular support which forms a radially outer casing 2. A concentric radially inner casing is also provided but is not shown.

The radially outer casing 2 and radially inner casing define an annular gas path 3. The radially outer casing 2 has a gas path surface 4 which faces into the gas path 3.

The vane 5 comprises an aerofoil section 6 having a tip 7 and a radially opposed base (not shown).

The tip 7 is received in an aperture 8 in the outer casing 2, the aperture being lined with a liner 26 which extends beyond the aperture 8 and radially outwards into the gas path 3.

In the embodiments shown in FIGS. 7, 8 and 10, the liner 26 is formed of silicone rubber/epoxy resin reinforced with carbon fibres. In these embodiments, the liner has a radially extending side surface 27 which is a concave radially extending side surface. This improves aerodynamic flow of gas in the gas path 3.

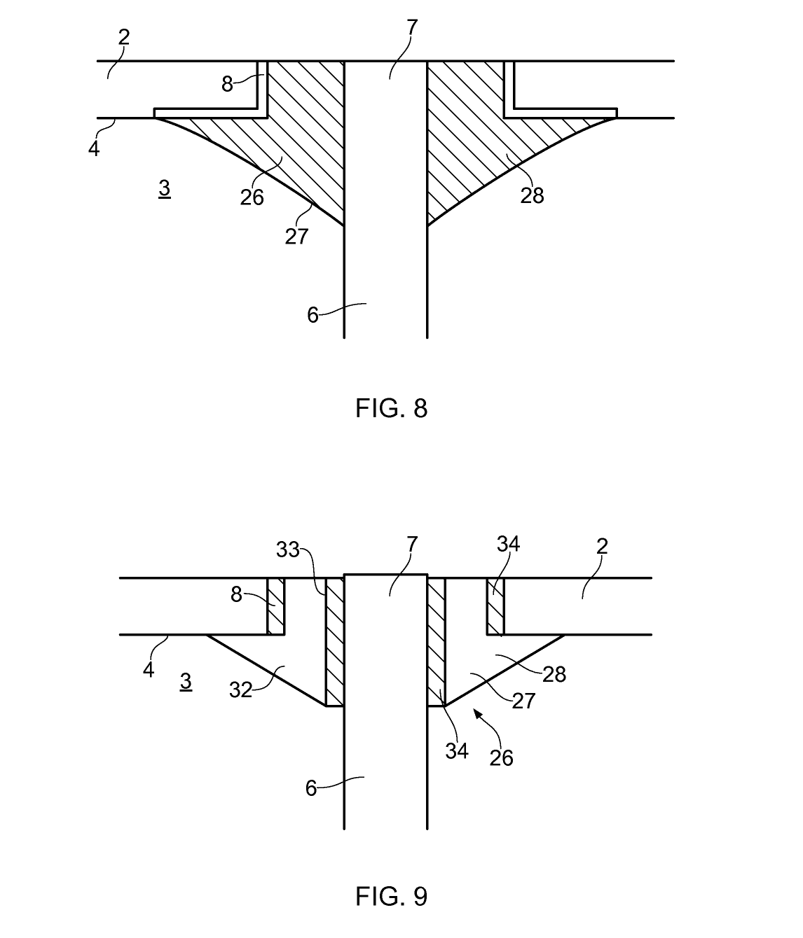

In the embodiment shown in FIGS. 8, 9 and 10, the liner 26 has a flange portion 28 extending axially from the respective aperture in abutment with the gas path surface 4 of the outer casing 2. The liner is affixed to the outer casing 2 within the aperture 8 using adhesive.

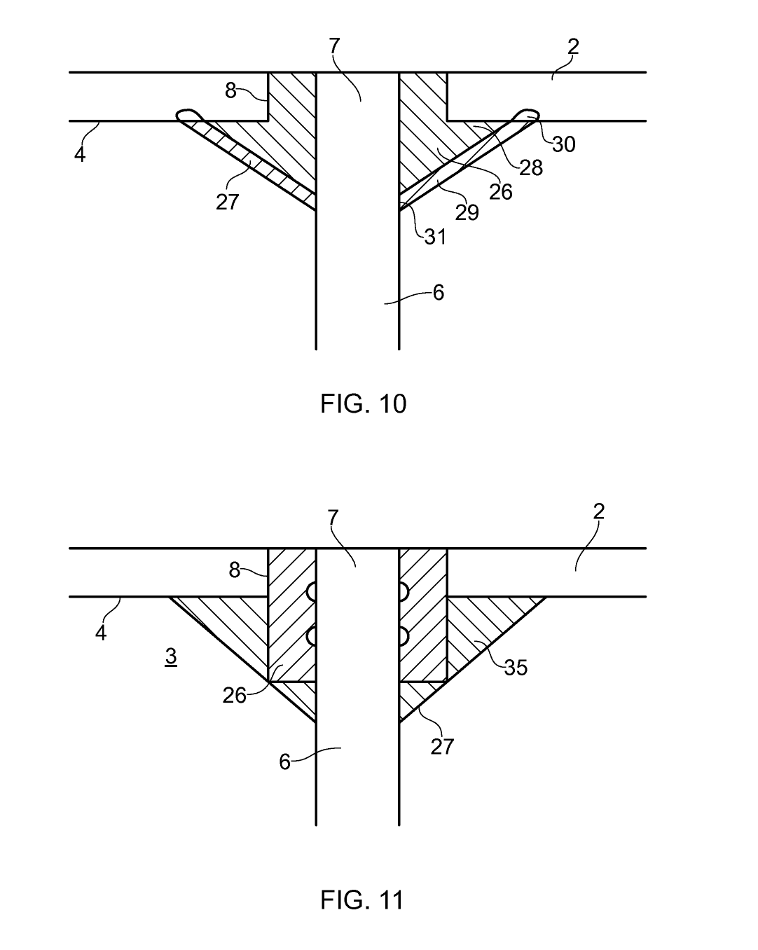

In the embodiment shown in FIG. 10, the radially extending side surface 27 is provided with a protective element 29 formed of rigid plastics material. The protective element 29 has a first end 30 for abutting the gas path surface 4 on the outer casing 2 and a second end 31 for abutting the aerofoil section 6 of the vane 5. The first end 30 of the protective element 29 is embedded into the gas path surface 4 of the outer casing 2.

In the embodiment shown in FIG. 9, the liner 26 is formed of a rigid plug 32 of plastics material having an aperture 33 lined with potting compound 34 which abuts the vane 5. The outer surface of the rigid plug 32 may also be lined with potting compound 34. The rigid plug 32 has a flange portion 28 extending axially in abutment with the gas path surface 4 of the outer casing 2. The flange portion has a radially extending side surface 27 which is concave radially extending side surface.

In the embodiments shown in FIG. 11, the liner 26 has a shape which is undesirable for aerodynamic flow and thus a smoothing coating 35 of silicone is provided. The smoothing coating 35 has a radially extending side surface 27 which is concave radially extending side surface.

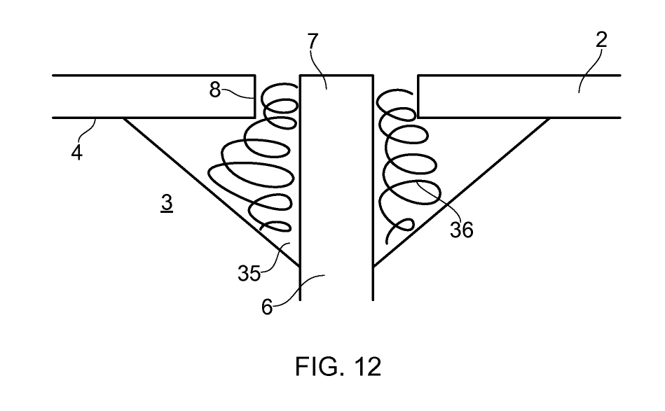

Similarly in the embodiment shown in FIG. 12 where the liner comprises a mechanical spring portion 36, a silicone smoothing coating 35 is provided to improve aerodynamic flow in the gas path 3.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

1. An annular support for a vane, the vane having an aerofoil section with a radially inner base and a radially outer tip, the annular support comprising a gas path surface which, in use, faces an annular gas path,
wherein the annular support is locally thickened by a projection extending radially from the gas path surface, the projection at least partly defining the perimeter of an aperture for receiving the tip or base of the aerofoil section.

2. A casing for a vane, the vane having an aerofoil section with a radially inner base and a radially outer tip, the casing comprising a radially inner casing and a radially outer casing defining an annular gas path therebetween,
wherein the radially inner casing is locally thickened by a projection extending radially outwards into the gas path, the projection at least partly defining the perimeter of an aperture for receiving the base of the aerofoil section and/or the radially outer casing is locally thickened by a projection extending radially inwards into the gas path, the projection at least partly defining the perimeter of an aperture for receiving the tip of the aerofoil section.

3. A vane assembly comprising:
a vane having an aerofoil section with a radially inner base and a radially outer tip;
a radially inner casing and a radially outer casing defining an annular gas path therebetween,
wherein the radially inner casing is locally thickened by a projection extending radially outwards into the gas path, the projection at least partly defining the perimeter of an aperture which houses the base of the aerofoil section and/or the radially outer casing is locally thickened by a projection extending radially inwards into the gas path, the projection at least partly defining the perimeter of an aperture which houses the tip of the aerofoil section.

4. A casing according to claim 2, wherein the radially inner casing is locally thickened by a projection extending radially outwards into the gas path, the projection at least partly defining the perimeter of an aperture which houses/for receiving the base of the aerofoil section and the radially outer casing is locally thickened by a projection extending radially inwards into the gas path, the projection at least partly defining the perimeter of an aperture which houses/for receiving the tip of the aerofoil section.

5. A support according to claim 1 wherein the or each projection has a radially extending side surface that is curved or sloped.

6. A support according to claim 1 wherein the or each aperture is at least partly lined with a liner.

7. A support according to claim 1 wherein the liner extends beyond the projection.

8. An annular support for a vane, the vane having an aerofoil section with a radially inner base and a radially outer tip, the annular support comprising:
a gas path surface which, in use, faces an annular gas path, the gas path surface having an aperture for receiving the tip or base of the aerofoil section, and
a liner lining the aperture,
wherein the liner extends from the aperture beyond the gas path surface.

9. A casing for a vane, the vane having an aerofoil section with a radially inner base and a radially outer tip, the casing comprising:
a radially inner casing having an aperture for receiving the radially inner base of the vane; and
a radially outer casing having an aperture for receiving the radially outer tip of the vane, the radially inner casing and radially outer casing defining an annular gas path therebetween; wherein the aperture in the radially inner casing is provided with a liner extending radially beyond the aperture outwards into the gas path and/or the aperture in the radially outer casing is provided with a liner extending radially beyond the aperture inwards into the gas path.

10. A vane assembly comprising:
a vane having an aerofoil section with a radially inner base and a radially outer tip;
a radially inner casing having an aperture housing the radially inner base of the vane; and
a radially outer casing having an aperture housing the radially outer tip of the vane, the radially inner casing and radially outer casing defining an annular gas path therebetween;
wherein the aperture in the radially inner casing is provided with a liner extending radially beyond the aperture outwards into the gas path and/or the aperture in the radially outer casing is provided with a liner extending radially beyond the aperture inwards into the gas path.

11. A support according to claim 8 wherein the portion of the or each liner extending beyond the respective aperture has a radially extending side surface which is curved or sloped.

12. (canceled)

13. (canceled)

14. An assembly according to claim 3 wherein the radially inner casing is locally thickened by a projection extending radially outwards into the gas path, the projection at least partly defining the perimeter of an aperture which houses/for receiving the base of the aerofoil section and the radially outer casing is locally thickened by a projection extending radially inwards into the gas path, the projection at least partly defining the perimeter of an aperture which houses/for receiving the tip of the aerofoil section.

15. A casing according to claim 2 wherein the or each projection has a radially extending side surface that is curved or sloped.

16. An assembly according to claim 3 wherein the or each projection has a radially extending side surface that is curved or sloped.

17. A casing according to claim 2 wherein the or each aperture is at least partly lined with a liner.

18. An assembly according to claim 3 wherein the or each aperture is at least partly lined with a liner.

19. A casing according to claim 2 wherein the liner extends beyond the projection.

20. An assembly according to claim 3 wherein the liner extends beyond the projection.

21. A casing according to claim 9 wherein the portion of the or each liner extending beyond the respective aperture has a radially extending side surface which is curved or sloped.

22. An assembly according to claim 10 wherein the portion of the or each liner extending beyond the respective aperture has a radially extending side surface which is curved or sloped.
